(19) United States
(12) Patent Application Publication
(10) Pub. No.: US 2012/0186754 A1
(43) Pub. Date: Jul. 26, 2012

(54) SECTIONAL DOOR PANEL AND METHOD OF THERMOFORMING

(76) Inventors: Christopher S. Klem, Saint Meinrad, IN (US); Brent Buschkoetter, Jasper, IN (US); Jay A. Kerkhoff, Velpen, IN (US); Brian Gehlhausen, Santa Claus, IN (US); Randy Ray Rhoades, Boonville, IN (US)

(21) Appl. No.: 13/351,604

(22) Filed: Jan. 17, 2012

Related U.S. Application Data
(60) Provisional application No. 61/434,451, filed on Jan. 20, 2011.

(51) Int. Cl. E06B 5/00; B23P 11/00; B29C 51/02

(52) U.S. Cl. 160/236; 264/242; 264/163; 29/428

(57) ABSTRACT

Disclosed is a panel section intended for assembly with other equivalent panel sections as a section door. The panel section includes two sheets thermoformed together to define a panel, an attachment tab, a living hinge unitarily formed between the panel and the attachment tab, a receiver portion configured to receive the attachment tab of an equivalent panel section when assembled as a sectional door, a first bearing surface and a second bearing surface, where the second bearing surface is configured to bear against the first bearing surface on the equivalent panel section when assembled as a sectional door. Also disclosed are a method of thermoforming the disclosed panel section and a method of assembling the disclosed sectional door.

### CROSS-REFERENCE TO RELATED APPLICATIONS

This application claims the benefit of U.S. Provisional Application No. 61/434,451 filed on Jan. 20, 2011, which is hereby incorporated by reference.

### BACKGROUND

Thermoforming is a manufacturing process where a plastic sheet is heated above its glass transition temperature, reformed into a desired shape in a mold, cooled below the glass transition temperature, removed from the mold and then trimmed to create a desired product. Twin sheet thermoforming expands on this process by bonding two separately thermoformed sheets together prior to cooling below the glass transition temperature to create more complex and/or thicker products.

During thermoforming, the edges of the plastic sheet are generally restrained from moving while the inner portion of the sheet is stretched and reshaped by the mold, sometimes with a differential pressure (e.g. negative vacuum pressure on the mold side of the sheet and/or positive pressure on the other side) pushing the sheet against the mold. This leaves excess material around the periphery of the molded part that is generally removed to create the final desired product. This excess material is known as offal. Offal removal can be accomplished by placing the molded product, including offal, in a jig configured to secure the product while the offal is removed by CNC cutting or machining.

Sectional doors include several separate panels that are hinged together and slide along a track to open and close. Several common examples of sectional doors include garage doors and semi-trailer overhead doors. Sectional doors have the advantage over conventional hinged doors or single panel monolithic overhead doors in that they do not require any space outside of the opening to open. Each panel of a sectional door is connected to the track on either side. Sectional doors may include a counterbalance system to neutralize the weight of the sectional door to assist in opening and closing the sectional door. For example, one or more tightly wound torsion springs on a steel shaft with cable drums on either end connected to the bottom of the sectional door by cables wound on the cable drums provides an example of a counterbalancing lift mechanism.

Living hinges are thin, flexible hinges made from plastic that joins two parts together while permitting those parts to bend along the line of the hinge (i.e., the living hinge flexes). Living hinges can generally be flexed with minimal friction and wear and can provide thousands or even millions of cycles without failure.

### BRIEF DESCRIPTION OF THE DRAWINGS

FIG. 1 is a front perspective view of a sectional door incorporating multiple panel sections.

FIG. 2 is a rear perspective view of the FIG. 1 sectional door.

FIG. 3 is a top view of a panel section of the FIG. 1 sectional door.

FIG. 4 is a side elevational view of the FIG. 3 panel section.

FIG. 5 is a front elevational view of the FIG. 3 panel section.

FIG. 6 is a bottom view of the FIG. 3 panel section.

FIG. 7 is a side cross sectional view of two panel sections joined together.

FIG. 8 is an exploded side cross sectional view of FIG. 7 taken within circle 8.

FIG. 9 is an enlarged cross sectional view of FIG. 7 taken inside circle 9.

FIG. 10 is a process diagram detailing a method of thermoforming a panel section.

FIG. 11 is a side cross sectional view of a panel section in an as molted configuration.

FIG. 12 is a side view of the FIG. 11 configuration.

FIG. 13 is a partial bottom view of the FIG. 6 panel section shown in an intermediate condition with offal still attached.

FIG. 14 is a partial side view of FIG. 4 taken inside circle 14.

FIG. 15 is a partial cross sectional view of FIG. 11 taken inside circle 15.

FIG. 16 is a partial cross sectional view of FIG. 11 taken inside circle 16.

FIG. 17 is a side cross sectional view of two panel sections joined together showing flex in the living hinges during opening or closing of the sectional door.

### DETAILED DESCRIPTION

Reference will now be made to certain embodiments and specific language will be used to describe the same. It will nevertheless be understood that no limitation of the scope of this disclosure and the claims are thereby intended, such alterations, further modifications and further applications of the principles described herein being contemplated as would normally occur to one skilled in the art to which this disclosure relates. In several figures, where there are the same or similar elements, those elements are designated with the same or similar reference numerals.

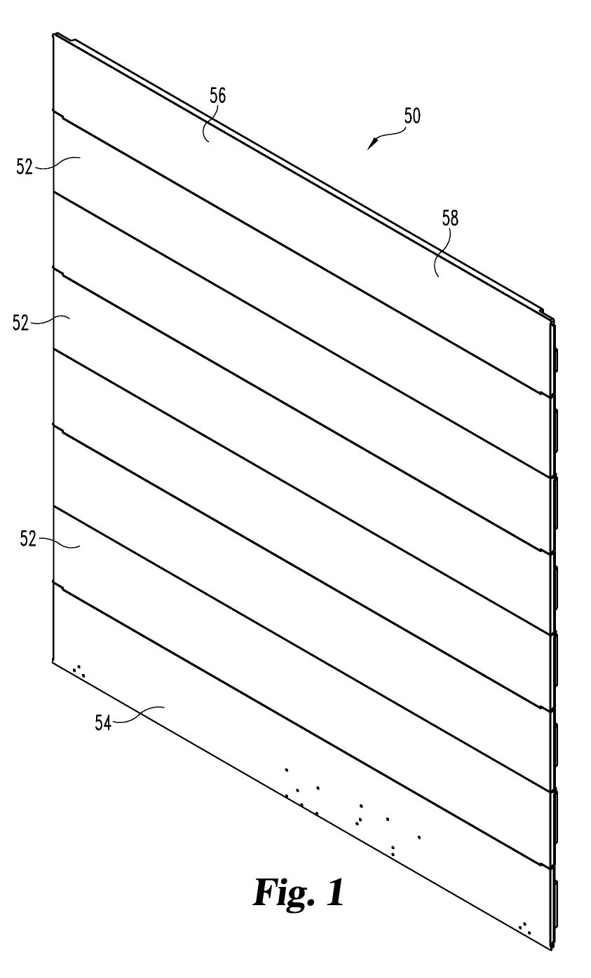

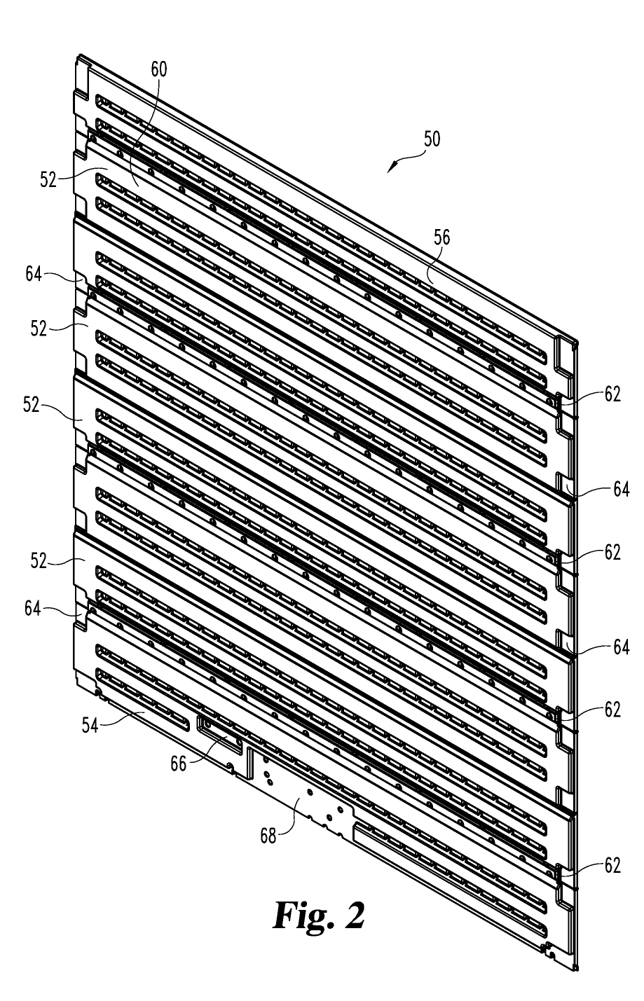

Referring to FIGS. 1 and 2, a sectional door 50 is illustrated. Sectional door 50 includes a plurality of panel sections 52, bottom panel section 54 and top panel section 56 attached together forming sectional door 50. In this context, sectional door refers to a door that includes separate hinged panels that slide along a slide track or other guide to open and close the door. Common examples include overhead garage doors and overhead vehicle trailer doors. Sectional door 50 illustrated in FIGS. 1 and 2 is configured as a vehicle trailer but the door described herein can be utilized for other desired door applications. Similarly, while overhead type doors are explicitly described herein, other sectional door configurations are intended to be covered, including section doors configured for side or bottom storage when opened.

Panel sections 52, 54 and 56 are coupled together by attachment tab 62 that is a part of panel sections 52 and 54. Details of this attachment are discussed below.

Each of panel sections 52, 54 and 56 include recesses 64 on the right and left side as shown in FIG. 2. Recesses 64 may be configured to accept attachment hardware to couple sectional door 50 to guides or rollers to be used in conjunction with a track or other guide mechanism to hold sectional door 50 in position and permit opening and closing sectional door 50 as is known in the art. Bottom panel section 54 also includes recesses 66 and 68. Recess 66, in the illustrated embodiment, is configured to attach a handle for opening and closing sectional door 50 while recess 68 is configured to accept a latching mechanism to secure sectional door 50 in a closed position and to provide an optional locking mechanism. The particular configuration of recesses 64, 66 and 68 is dependent upon the desired hardware to be attached to sectional door 50 and can be varied or omitted as appropriate.

Section door 50 includes outer surface 58 as shown in FIG. 1 and inner surface 60 as shown in FIG. 2. The illustrated outer surface 58 is substantially flat and is adapted to receive painting, printing and/or signage for use in conjunction with a vehicle.

The following includes a detailed description of panel section 52. It should be understood that many of the features described below with regard to panel section 52 are equally applicable to bottom panel section 54 and top panel section 56. Bottom panel section 54 and top panel section 56 are not otherwise described.

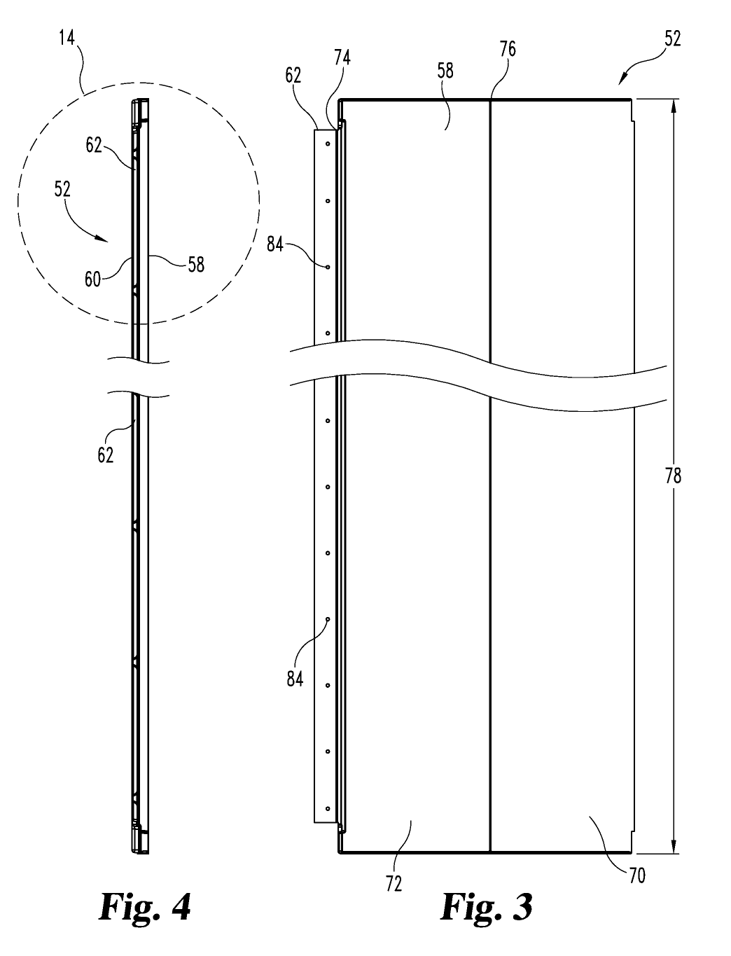

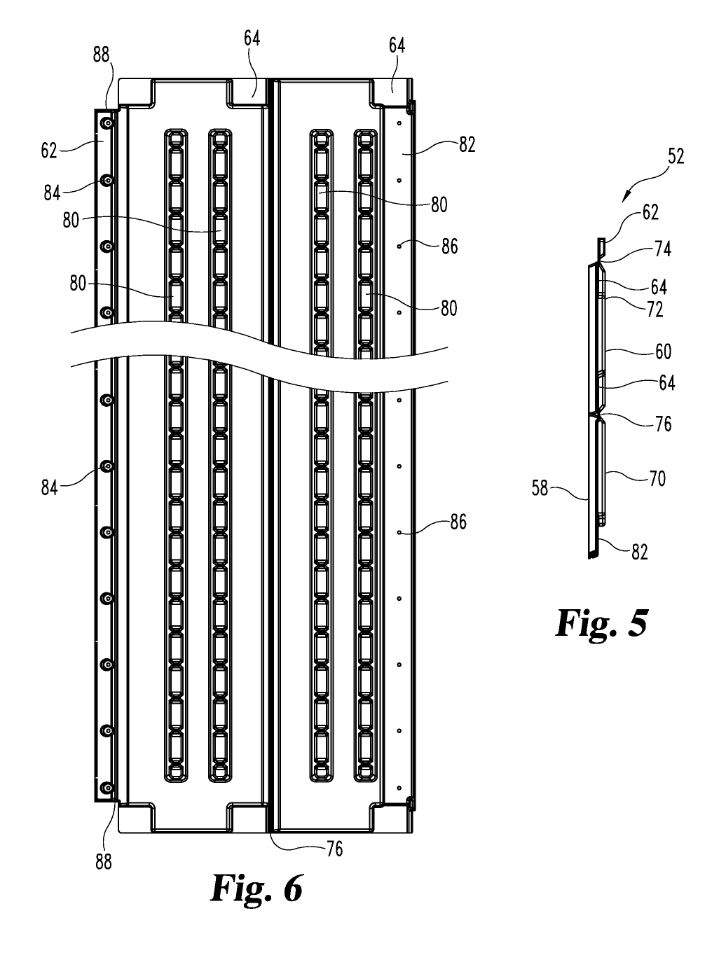

Referring to FIGS. 3-6, panel section 52 is illustrated. Panel section 52 includes attachment tab 62, panel portions 70 and 72, living hinges 74 and 76, outer surface 58, inner surface 60 and ribs 80. Living hinge 74 delimits attachment tab 62 and panel portion 72. Living hinge 76 delimits panel portions 70 and 72. As described below, attachment tab 62, panel portions 70 and 72 and living hinges 74 and 76 are integrally formed as a monolithic structure. The top and bottom of attachment tab 62 and living hinge 74 are defined by edge 88. In this context, “living hinge” refers to a thinned, flexible plastic hinge, that both joins two parts together and permits those parts to bend along the line of the hinge. Panel portion 52 is illustrated in a broken configuration to permit additional details to be shown. It should be understood that panel portion 52 has overall width 78 that is configurable to fit a desired door width. As discussed above, outer surface 58 of panel section 52 includes a substantially flat surface conversely inner surface 60 of panel section 52 includes a plurality of ribs 80 that are optionally included for stiffness and strength as further discussed below.

As best shown in FIG. 6, panel portion 70 defines receiver portion 82 that is configured to receive attachment tab 62. Attachment tab 62 includes a plurality of fastener holes 84 spaced along its length while receiver portion 82 includes a plurality of fastener holes 86 spaced along its length mirroring the positions of fastener holes 84. Comparison of FIGS. 3 and 6 show that fastener holes 84 are through holes while fastener holes 86 only pass through inner surface 60 but do not penetrate outer surface 58. This is discussed in additional detail below.

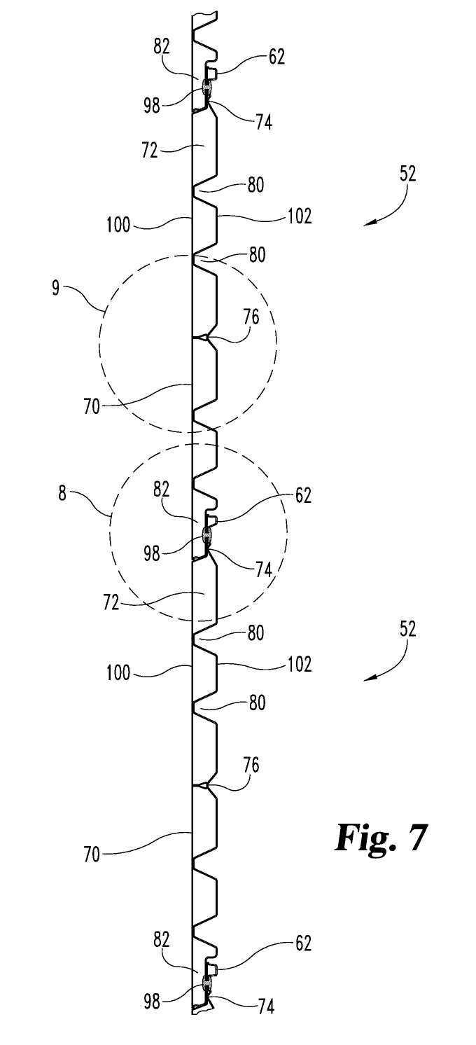

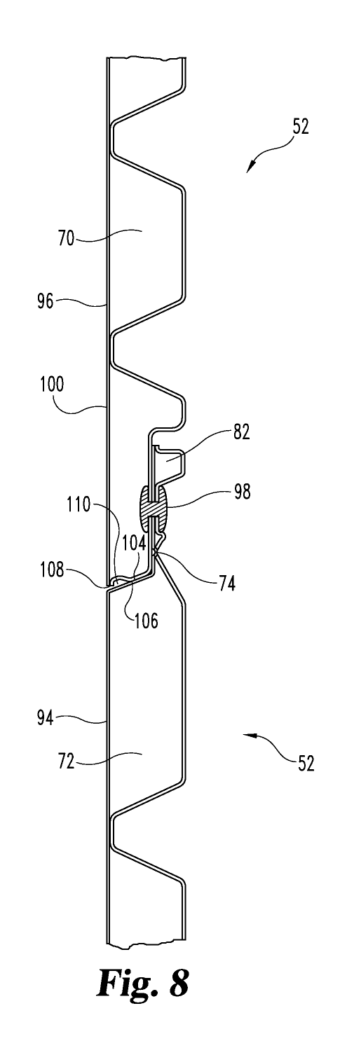

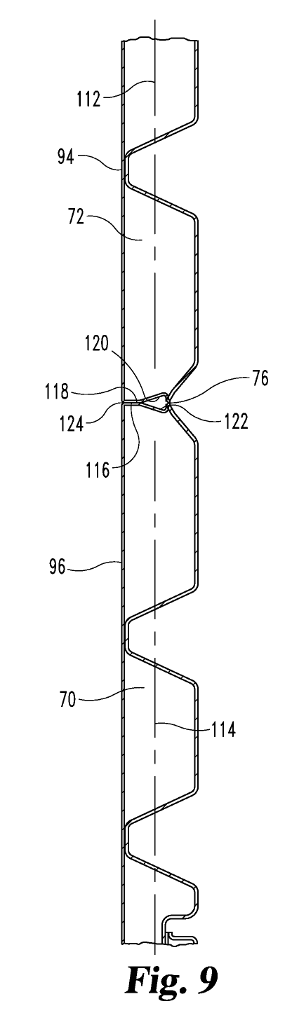

Referring now to FIGS. 7-9, two panel sections 52 are illustrated coupled together by fastener 98. While FIGS. 7 and 9 illustrate a cross section and thus show only a single fastener 98, it should be understood that a plurality of fasteners 98 are utilized to fasten panel sections 52 together via fastener holes 84 and 86 as discussed above. As previously discussed, each panel section 52 includes panel portions 70 and 72 separated by living hinge 76 and living hinge 74 separates attachment tab 62 from panel portion 70.

Outer surface 58 includes outer surface 94 on panel portion 70 and outer surface 96 on panel portion 72. In the illustrated cross section, panel portion 52 includes outer sheet 100, inner sheet 102, and weld seam 108. Panel portion 70 defines longitudinal axis 112 and panel portion 72 defines longitudinal axis 114, outer sheet 100 defines bearing surfaces 116 and 118 and recesses 120 and 122. Inner sheet 102 defines bearing surfaces 104 and 106 and recess 110.

When assembled as sectional door 50, panel sections 52 are arranged in an abutting relationship with bearing surface 104 directly abutting and bearing against bearing surface 106. When aligned and arranged in this way, fastener holes 84 and 86 are configured to align permitting placement of fastener 98. As discussed above, fastener 98 can be configured to pass through attachment tab 62 and only inner sheet 102 to secure the two panel sections 52 together without affecting outer sheet 100.

In the illustrated embodiment, fastener 98 is a rivet type fastener that has a blind side expander that is insertable through a hole and then later expanded to complete the fastener, as is well known in the art. Other embodiments (not illustrated) use other types of fasteners as desired. For example, fastener hole 86 could include an integral nut body, and fastener 98 could include a threaded bolt. In yet other embodiments, attached tab 62 could be joined to receiver portion without a mechanical fastener by welding or adhesive. In yet other embodiments (not illustrated), fastener 98 could pass through outer sheet 100. Any desired method may be used to join panels together.

As discussed in greater detail below, in the illustrated embodiment, outer sheet 100 and inner sheet 102 are thermoformed together and include welded seam 108. Welded seam 108 is separated from bearing surface 106 by recess 110 with receiver portion 82 and weld seam 108 configured so that welded seam 108 does not contact bearing surface 104 (or any other part of the attached panel section 52).

Referring to FIG. 9, an enlarged view proximate to living hinge 76 is illustrated. Bearing surfaces 116 and 118 are configured to abut and bear against each other when longitudinal axes 112 and 114 are aligned as illustrated. Panel portions 70 and 72 also define recesses 120 and 122 that separate bearing surfaces 116 and 118 from living hinge 76. Recess 120 and 122 are configured to never contact each other.

Bearing surfaces 104, 106, 116 and 118 are configured to support and transfer compressive loads across the illustrated abutting surfaces.

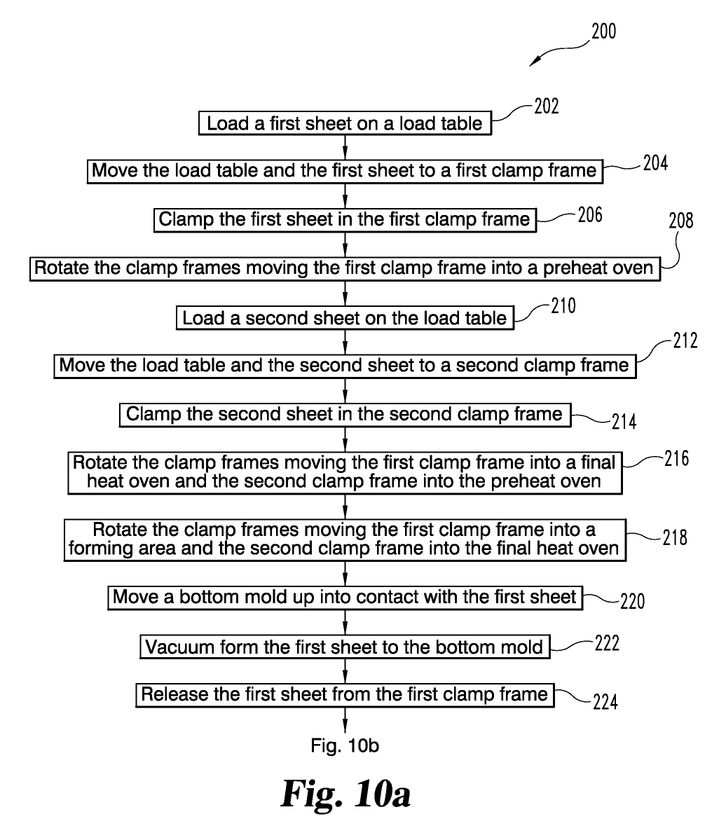

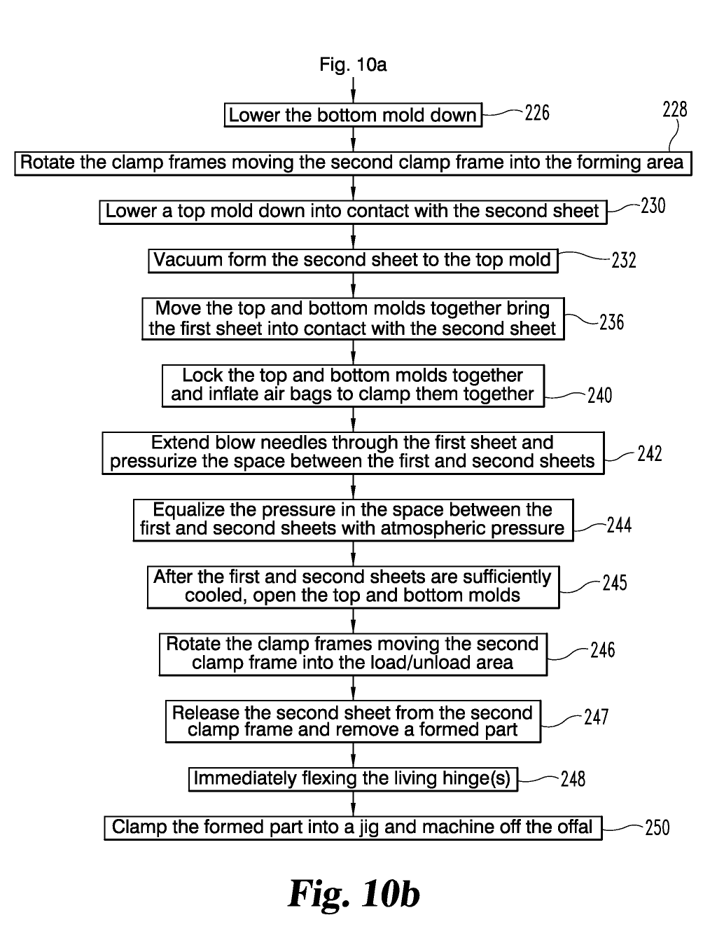

Referring now to FIG. 10, process 200 is illustrated. Process 200 details many process steps that could be used to thermoform panel section 52. However, process 200 is not all-inclusive and many additional steps would be apparent to a person of ordinary skill in the art. The steps described in process 200 generally involve a multi-station thermoforming machine that includes at least four stations that move plastic sheets between the four stations by a set of clamp frames that rotate between the four positions. The four positions include a load/unload station, a first preheat oven, a second final heat oven and a molding position where thermoforming takes place. The manufacturing process described herein is related to making a single unit. It should be understood that this manufacturing process is intended to be used as a continuous process where the actions described for each station repeatedly reoccur, facilitating continuous production of manufactured parts. Furthermore, while a multi-station thermoforming machine is described, process 200 is intended to be adapted to whatever type of thermoforming machine is desired with appropriate modifications to account for known differences. Similarly, process 200 is intended to be adaptable by persons skilled in the art to other types of multi-station thermoforming machines that are not explicitly described, for example, thermoforming machines that clamp two sheets in a single clamp frame, as known in the art.

In any event, process 200 begins with step 202. In step 202 inner sheet 102 is loaded onto a load table in the load/unload station. In step 204 the load table is moved up to bring inner sheet 102 into the boundaries of a first clamp frame and in step 206 the clamp frame clamps inner sheet 102 around the periphery to secure inner sheet 102 within the clamp frame. The load table is then lowered back down to the load position.

Process 200 continues with step 208 where the clamp frames are rotated moving the first clamp frame into the preheat oven and moving a second clamp frame into position in the load/unload station and in step 210. In step 210 outer sheet 100 is loaded onto the load table and in step 212 the load table is moved up, positioning outer sheet 100 within the second clamp frame. In step 214, outer sheet 100 is clamped within the second clamp frame and the load table is lowered.

Process 200 continues with step 216 where the clamp frames are rotated again, moving the first clamp frame into the final heat oven and the second clamp frame into the preheat oven. This is followed by step 218 where the clamp frames are rotated yet again moving the first clamp frame into the forming area and the second clamp frame into the final heat oven. By this time, inner sheet 102 should be heated above its glass transition temperature. Immediately after moving the first clamp frame in the forming area, a bottom mold is moved into contact with the first sheet in step 220. In step 222, a vacuum assist is utilized to form inner sheet 102 to the bottom mold. After inner sheet 102 is formed to the bottom mold then inner sheet 102 is released from the first clamp frame in step 224 and the bottom mold and inner sheet 102 are lowered down in step 226.

This is followed by step 228 where the clamp frames are rotated again, moving the second clamp frame into the forming area where the top mold is lowered down into contact with outer sheet 100 in step 230 and then subsequently vacuumed formed to conform to the shape of the top mold in step 232. Outer sheet 100 continues to be retained in the second clamp after being formed to conform to the top mold.

In step 236, the top and bottom molds are brought together bringing portions of the inner sheet 102 into contact with the outer sheet 100. This is followed by step 240 where the top and bottom molds are locked together with bayonets and air bags are inflated to create a tight seal and clamp the top and bottom molds together. Next in step 242, blow needles are extended through inner sheet 102 and pressurized as is applied through the blow needles to the spaces between inner sheet 102 and outer sheet 100. This could include slightly pressurizing the space and also removing hot air from the space by opening some of the needles to atmosphere while pressurizing other vents. This could also include sequentially applying pressure through the needles at high and low pressure while some of the needles are open to atmosphere. Generally, pressurized air is injection in approximately half of the needles while the remaining needles are vented to atmosphere. This creates a small positive pressure and an air flow that helps remove hot air captured between outer sheet 100 and inner sheet 102. In other instances, high pressure air is injected to assist in forming the part against the molds for a portion of step 242.

This is followed by equalizing the pressure in the space between the first and second sheets with atmospheric pressure through the needles in step 244 to prevent ballooning or collapse of the part due to differential pressure between the interior space and the atmosphere. This also allows any heat gradients in the space between the sheets to equalize. The blow needles are then retracted from inner sheet 102. Note that while process 200 describes the blow needles only extending through inner sheet 102, the blow needles can extend through any surface desired, including outer sheet 100.

After sheets 100 and 102 are sufficiently cooled, bonded and welded together, the top and bottom molds are opened in step 245. This is followed by step 246 where the clamp frames are rotated, moving the second clamp frame into the load/unload station where, in step 247, the second clamp frame is opened, releasing the second sheet and formed panel section 52 is removed. Immediately after removing the formed panel section 52, living hinge(s) 74 and 76 are flexed in step 248. To facilitate this, edges 88 may optionally be die cut between the top and bottom molds in step 240. After the formed part is removed it is clamped in a jig and the offal is machined off in step 250, completing panel section 52.

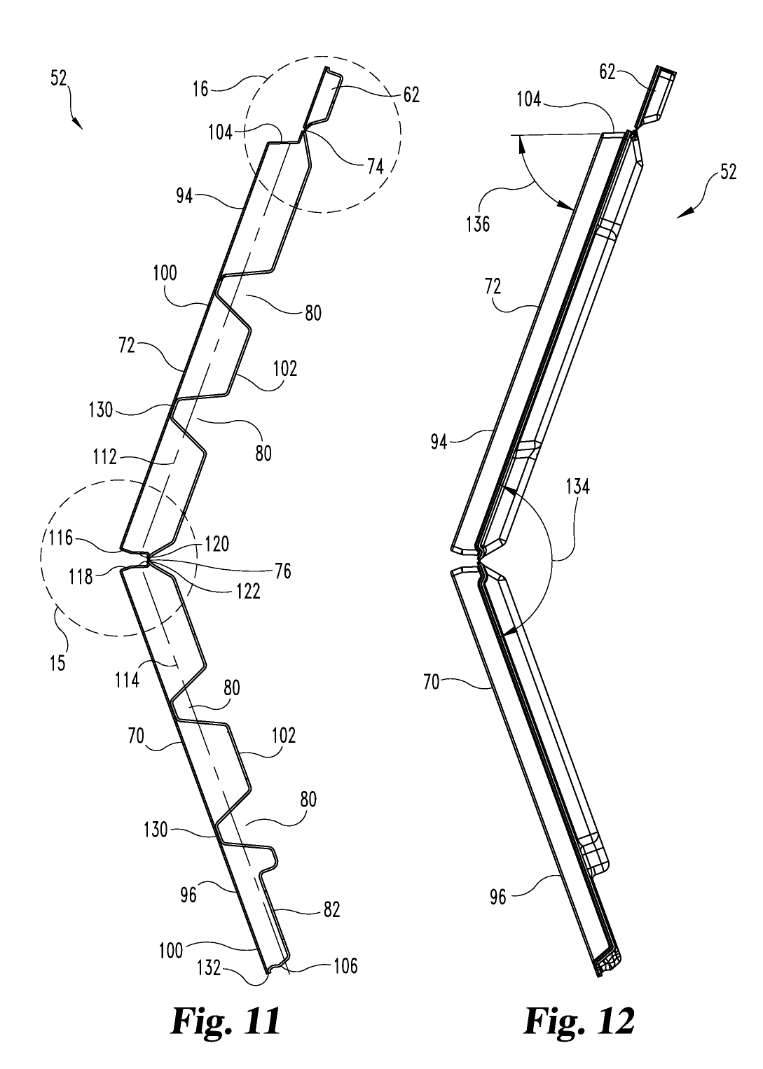

Referring now to FIGS. 11 and 12, panel section 52 is illustrated as oriented during thermoforming in process 200. (Note that FIGS. 11 and 12 are rotated 90 degrees to better fit on the page.) In one manufacturing orientation, the illustrated panel section 52 would be orient in a “V” configuration, with living hinge 76 positioned below living hinge 74.

FIG. 11 illustrates a cross sectional view of panel section 52 showing melt bonds 130 and 132 between outer sheet 100 and inner sheet 102. Melt bonds 130 are positioned at the top of ribs 80 and represents an optional technique to stiffening panel section 52 by increasing the points of contact between outer sheet 100 and inner sheet 102 and by providing increased web structures between outer sheet 100 and inner sheet 102. Melt bond 132 is on the outer edge near receiver portion 82 and corresponds to weld seam 108 prior to machining.

Living hinges 74 and 76 also represent a point of melt bonding between outer sheet 100 and inner sheet 102. However, the relative force applied to the areas of living hinges 74 and 76 are substantially higher than melt bonds 130 and 132 to facilitate forming living hinges 74 and 76. In process 200 this is accomplished by including a movable insert in the top and/or bottom molds that's position can be adjusted along the length of living hinges 74 and 76, for example by shimming the movable insert. This permits control of the thickness of living hinges 74 and 76.

As shown in FIG. 11, longitudinal axis 112 and 114 of panel portions 70 and 72 are angled apart by mold angle 134 during thermoforming. In the illustrated embodiment, mold angle 134 is equal to approximately 140°. In other embodiments (not illustrated) mold angle 134 could be between approximately 130° and 150°.

As shown in FIG. 12, bearing surface 104 is angled from longitudinal access 112 by angle 136. In the illustrated embodiment, angle 136 is equal to approximately 70°. In other embodiments, angle 136 may be equal to approximately half of mold angle 134.

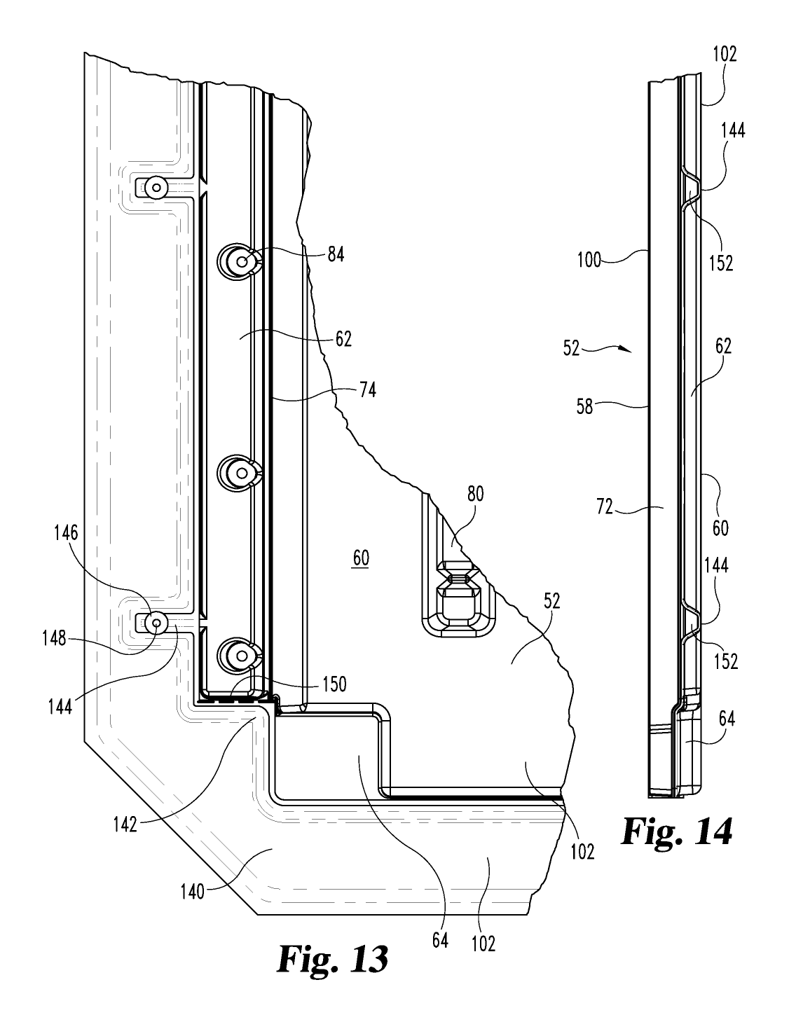

Referring to FIG. 13, a partial bottom view of panel section 52 is illustrated showing panel section 52 in an incomplete state as it may appear after step 246 in procedure 200 but before steps 248 or 250. As illustrated in FIG. 13, panel section 52 includes offal 140, weld seam 142, vent 144, receptor 146, needle hole 148 and die cut score line 150. Offal 140 includes the portions of inner sheet 102 (and outer sheet 100 which is not visible in this view but is located on the opposite side) that is gripped by the clamp frames and which provide a reservoir of plastic material for draw down during molding. Offal 140 includes most of weld seam 142 that defines the outer periphery of panel section 52. Vent 144 and receptor 146 are molded structures that extend into the offal area to provide venting of the interior spaces defined by attachment tab 62. Receptor 146 is configured to receive a blow needle in step 242 of procedure 200. Vent 144 provides an internal passageway between receptor 146 and the interior space between outer sheet 100 and inner sheet 102 in attachment tab 62. Needle hole 148 depicts the hole where the blow needle extended through inner sheet 102.

Also shown in FIG. 13 is die cut score line 150 along the bottom of attachment tab 62 and living hinge 74. Die cut score line 150 is located in weld seam 142 and may represent either a thinned portion of weld seam 142 or a through cut. Panel section 52 shown in FIG. 13 is machined in step 250 of procedure 200 to the final configuration illustrated in FIGS. 3-6 by machining or cutting off offal 140 along weld seam 142. Vent 144 and interceptor 146 are machined or cut off and removed with the offal.

Referring to FIG. 14, partial side view of panel section 52 is illustrated mirroring the portion of panel section 52 shown in FIG. 13. As shown in FIG. 14, machining or cutting vent 144 off leaves passage 152 through the sidewall of attachment tab 62.

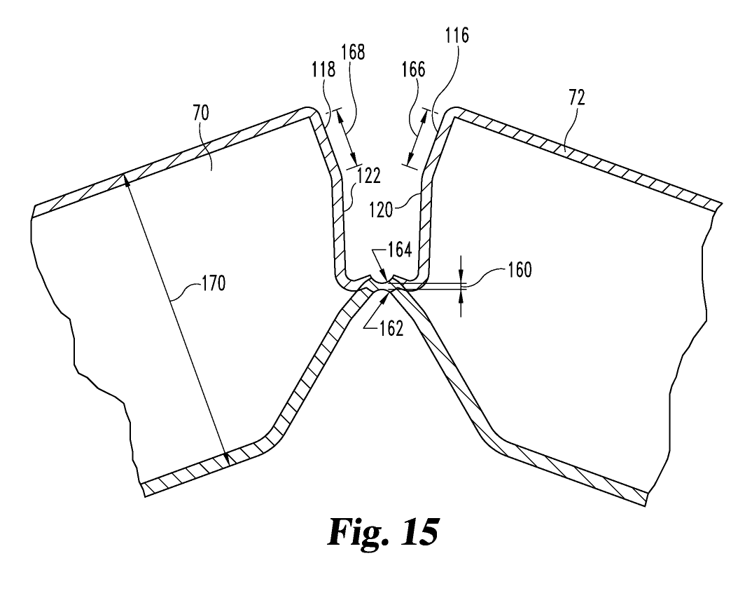

Referring to FIG. 15, an enlarged view of the FIG. 11 cross section of panel section 52 proximate to living hinge 76 is illustrated. As shown in FIG. 15, living hinge 76 includes thickness 160, bottom radius 162, top radius 164, with bearing surface 116 having a length 166 and bearing surface 118 having length 168. In the illustrated embodiment, thickness 160 is approximately equal to 0.030 inches. In other embodiments, thickness 160 can vary between approximately 0.028 and 0.040 inches thick. In the illustrated embodiment, radiuses 162 and 164 are both equal to approximately 0.063 inches and lengths 166 and 168 are both equal to approximately 0.29 inches. In other embodiments, lengths 166 and 168 can vary between approximately 0.10 and 0.30 inches. In the illustrated embodiment, panel width 170 is equal to approximately 1.5 inches.

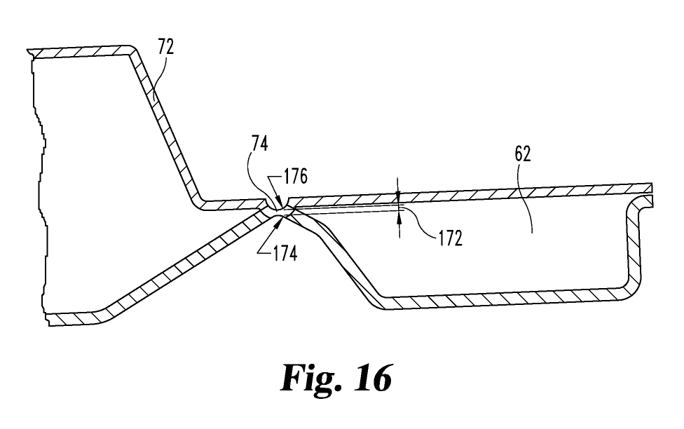

Referring to FIG. 16, an enlarged view of FIG. 11 proximate to living hinge 74 is illustrated showing living hinge thickness 172, top radius 176 and bottom radius 174. In the illustrated embodiment, thickness 172 is approximately equal to 0.030 inches. In other embodiments, thickness 172 can vary between approximately 0.028 and 0.040 inches thick. In the illustrated embodiment, radiuses 174 and 176 are both equal to approximately 0.063.

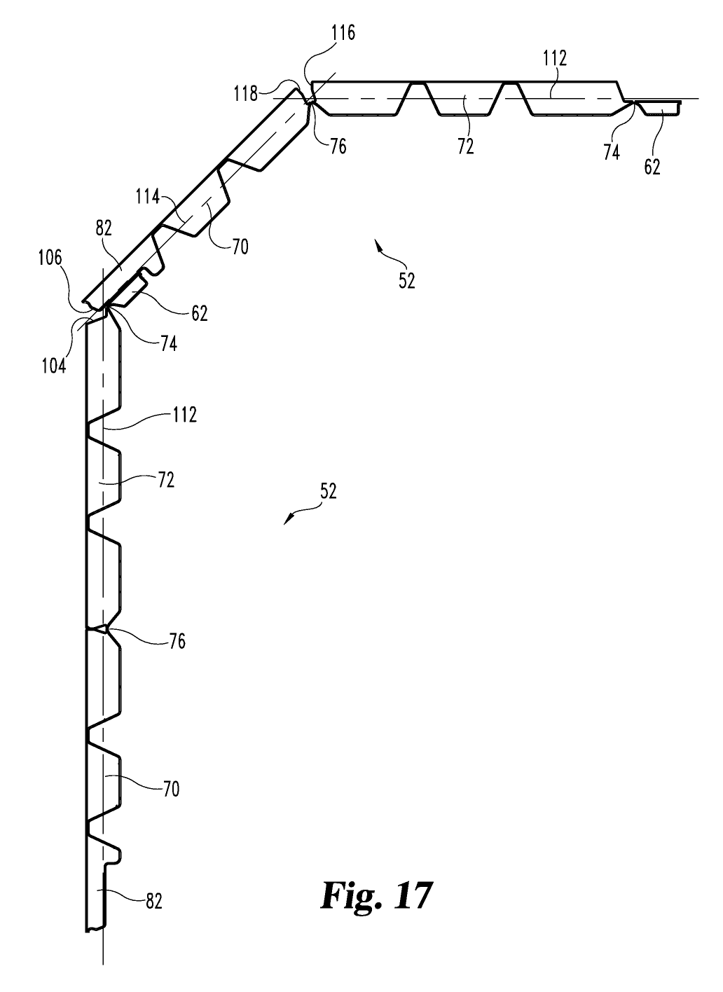

Referring to FIG. 17, a cross sectional view of two panel sections 52 is illustrated with panel sections 52 joined together at attachment tab 62 and receiver portion 82 as discussed above. The upper panel section 52 is shown flexed through an approximate 90° bend as would be typical when opening or closing most sectional doors. In particular, in the upper panel section 52, longitudinal axes 112 and 114 are angled apart by approximately 135° while longitudinal axis 114 on the upper panel section 52 and longitudinal axis 112 on the lower panel section 52 are also angled apart by approximately 135°. Bearing surfaces 116 and 118 on the upper panel section do not bear against each other. Similarly bearing surface 106 on the upper panel section 52 does not bear against bearing surface 104 on the lower panel section 52 (as compared to what is illustrated in FIGS. 7-9).

This disclosure serves to illustrate and describe the claimed invention to aid in the interpretation of the claims. However, this disclosure is not restrictive in character because not every embodiment covered by the claims is necessarily illustrated and described. All changes and modifications that come within the scope of the claims are desired to be protected, not just those embodiments explicitly described.

We claim:

1. A panel section for assembly with an equivalent panel section as a sectional door, the panel section comprising:
a first sheet and a second sheet thermoformed together defining a first panel portion and a first longitudinal axis, wherein said first sheet defines a first outer surface;
an attachment tab unitarily formed with the first panel portion;
a first living hinge unitarily formed between said attachment tab and said first panel portion;
a receiver portion constructed and arranged to receive the attachment tab of the equivalent panel section when the panel section is assembled as the sectional door;
a first bearing surface on the first panel portion;
a second bearing surface constructed and arranged to substantially bear against the first bearing surface of the equivalent panel section when the panel section is assembled as the sectional door and when the first longitudinal axes of both panel sections substantially are aligned.

2. The panel section of claim 1, wherein said receiver portion and said attachment tab are constructed and arranged so that a plurality of fasteners can couple the panel section to the equivalent panel section by passing through the attachment tab and the second sheet of the receiver portion on the equivalent panel section without passing through the first outer surface of the equivalent panel section.

3. The panel section of claim 1, wherein said first outer surface is substantially flat.

4. The panel section of claim 3, wherein the longitudinal axis is approximately parallel to the outer surface.

5. The panel section of claim 1, wherein the panel section has a width and wherein the first living hinge is continuous and extends across substantially the entire width.

6. The panel section of claim 1, further comprising a machined weld seam between said first and second sheets and between said second bearing surface and said first outer surface proximate to said second bearing surface, wherein said machined weld seam is constructed and arranged to never contact the equivalent panel section when assembled as the sectional door.

7. The panel section of claim 1, wherein the panel section further comprises:
a second living hinge unitarily formed between said first panel portion and a second panel portion, wherein said first panel portion defines the first longitudinal axis and said second panel portion defines a second longitudinal axis;
a third bearing surface on the first panel portion;
a fourth bearing surface on the second panel portion constructed and arranged so that said third and forth bearing surfaces substantially bear against each other when the first and second longitudinal axes are substantially aligned.

8. The panel section of claim 7, wherein the first panel portion defines a first recess between said third bearing surface and said second living hinge, and wherein said second panel portion defines a second recess between said fourth bearing surface and said second living hinge and wherein said first and second recesses are constructed and arranged to never contact each other.

9. The panel section of claim 7, wherein the panel section has a width and wherein the second living hinge is continuous and extends across substantially the entire width.

10. The panel section of claim 7, wherein said first panel portion defines said first outer surface, wherein said second panel portion defines a second outer surface and wherein said panel section is constructed and arranged so that said first and second outer surfaces substantially align and adjoin with minimal discontinuity therebetween when the first and second longitudinal axes are substantially aligned.

11. The panel section of claim 10, further comprising a machined weld seam between said first and second sheets and between said second bearing surface and said second outer surface proximate to said second bearing surface, wherein said machined weld seam is constructed and arranged to never contact the equivalent panel section when assembled as the sectional door.

12. The panel section of claim 1, wherein the first and second bearing surfaces are substantially planar.

13. The panel section of claim 1, wherein the first bearing surface is angled approximately 60 to 90 degrees from the first longitudinal axis.

14. The panel section of claim 1, wherein said first bearing surface is angled approximately 70 degrees from the longitudinal axis.

15. The panel section of claim 1, wherein said first bearing surface defines a plane that is substantially perpendicular to said first living hinge.

16. A method of thermoforming a panel section, the method comprising:
thermoforming a first sheet defining a first outside surface, a first bearing surface and a first longitudinal axis of a first panel portion and a second outside surface, a second bearing surface and a second longitudinal axis of a second panel portion, wherein the first and second longitudinal axes are angled between approximately 130 and 150 degrees during thermoforming;
thermoforming a second sheet defining a first inside surface of the first panel portion and a second inside surface of the second panel portion; and
compressing the first and second sheets together creating a living hinge between the first and second panel portions and bonding the first and second sheets together.

17. The method of claim 16, further comprising:
while compressing the first and second sheets, die cutting the first and second sheets on both ends of the living hinge; and
substantially immediately after compressing the first and second sheets together, flexing the living hinge.

18. The method of claim 16, wherein the first and second longitudinal axes are angled approximately 140 degrees apart during thermoforming

19. A method of assembling a sectional door, the method comprising:
abutting a first bearing surface on a first panel section against a second bearing surface on a second panel section, wherein the first panel section includes a unitarily formed living hinge that divides an attachment tab from a panel portion and wherein the second panel section includes a receiver portion constructed and arranged to receive the attachment tab;
attaching the attachment tab to the receiver portion wherein the unitarily formed living hinge bends to allow angular movement of the second panel section with respect to the first panel section and wherein the second bearing surface substantially bears against the first bearing surface when the first and second panel sections are substantially aligned.

20. The method of claim 19, further comprising:
installing a plurality of mechanical fasteners through the attachment tab and an inner wall of the second panel section without passing through an outer surface of the second panel section to attach the attachment tab to the second panel section.

21. A panel section of a sectional door, the panel section comprising:
a first sheet and a second sheet together defining a first panel portion having a first longitudinal axis and a second panel portion having a second longitudinal axis;
a living hinge unitarily formed from the first and second sheet between the first panel portion and the second panel portion;
a first bearing surface on the first panel portion;
a second bearing surface on the second panel portion constructed and arranged so that said first and second bearing surfaces substantially bear against each other when the first and second longitudinal axes are substantially aligned.

22. The panel section of claim 21, wherein the first panel portion defines a first recess between said first bearing surface and said living hinge, and wherein said second panel portion defines a second recess between said second bearing surface and said second living hinge and wherein said first and second recesses are constructed and arranged to never contact each other.

23. The panel section of claim 21, wherein the panel section has a width and wherein the living hinge is continuous and extends across substantially the entire width.

24. The panel section of claim 21, wherein said first sheet defines a first outer surface on the first panel portion and a second outer surface on the second panel portion and wherein said panel section is constructed and arranged so that said first and second outer surfaces substantially align and adjoin with minimal discontinuity therebetween when the first and second longitudinal axes are substantially aligned.
